(19) United States
(12) Patent Application Publication
(10) Pub. No.: US 2026/0220528 A1
(43) Pub. Date: Jul. 30, 2026

(54) MULTI-MODAL MACHINE LEARNING FRAMEWORK FOR GENERATING AN AGGREGATED CLASSIFICATION SCORE FOR A DATA OBJECT

(71) Applicant: Optum, Inc., Minnetonka, MN (US)

(72) Inventors: Gaurav Mantri, Gurugram (IN); Vishwakant Gupta, Jaipur (IN); Jahanvi Talwar, Indore (IN); . Shubhangi, Noida (IN); Jyoti Gupta, Moradabad (IN)

(21) Appl. No.: 19/040,290

(22) Filed: Jan. 29, 2025

(51) Int. Cl. G06N 20/00

(52) U.S. Cl. CPC G06N 20/00

(57) ABSTRACT

Various embodiments of the present disclosure provide a multi-modal machine learning framework for generating an aggregated classification score for a data object. The techniques comprise generating (i) a first object feature set for a first machine learned model, (ii) a second object feature set for a second machine learned model, and (iii) a domain knowledge feature set associated with a domain knowledge profile for a data object, applying the first machine learned model to the first object feature set and the domain knowledge feature set to generate a first classification score for the data object, applying the second machine learned model to the second object feature set and the domain knowledge feature set to generate a second classification score for the data object, and generating an aggregated classification score for the data object based on the first classification score and the second classification score.

### BACKGROUND

Traditional data processing engines may process a third-party dataset via a model such as a machine learned model, associated with a data processing task. However, a third-party dataset is often not adequately formatted and/or does not contain adequate quality of data for a particular data processing task such as a particular machine learning task. As such, performing such data processing tasks using traditional data processing engines is error prone and/or resource intensive.

### BRIEF DESCRIPTION OF THE DRAWINGS

FIG. 1 depicts an example overview of an architecture in accordance with some embodiments of the present disclosure.

FIG. 2 depicts an example predictive data analysis computing entity in accordance with some embodiments of the present disclosure.

FIG. 3 depicts an example client computing entity in accordance with some embodiments of the present disclosure.

FIG. 4 depicts a dataflow diagram showing example data structures, modules, and/or pipelines for providing a multi-modal machine learning framework in accordance with some embodiments of the present disclosure.

FIG. 5 depicts a dataflow diagram showing example data structures, modules, and/or pipelines for enabling a multi-modal machine learning framework in accordance with some embodiments of the present disclosure.

FIG. 6 depicts an interactive visualization system showing example devices, systems, engines, data structures, and/or processes for generating one or more user interface elements for rendering via a user interface in accordance with some embodiments of the present disclosure.

FIG. 7 depicts an example system for providing prediction-based actions and/or visualizations in accordance with some embodiments of the present disclosure.

FIG. 8 depicts example user interface in accordance with some embodiments of the present disclosure.

FIG. 9 depicts a flowchart diagram of example process for providing a multi-modal machine learning framework for generating an aggregated classification score for a data object in accordance with some embodiments of the present disclosure.

### DETAILED DESCRIPTION

Various embodiments of the present disclosure provide a multi-modal machine learning framework that assesses the quality of a data object to enable improved machine learning via a downstream classifier model. To do so, some embodiments of the present disclosure provide a data processing pipeline that utilizes multi-modal machine learning to generate a set of classification scores for a data object that may be leveraged as a feature set by a downstream classifier model. The downstream classifier model may be an aggregation layer for the multi-modal machine learning framework. In some embodiments of the present disclosure, the multi-modal machine learning framework may implement a feature extraction technique (e.g., prior to the intermediate classification scores) that may create a unique feature set for the data object tailored to a particular machine learning task. In some embodiments, the plurality of classification scores may be utilized by the classifier model to provide an aggregated classification score for the data object. This, in turn, enables an improved data processing pipeline integrated with machine learning that directly addresses technical challenges within the realm of traditional data processing techniques, such as inaccurately formatted data for a particular data processing task (e.g., a particular machine learning task), resource intensive processing and/or reprocessing of data due to inaccurately formatted data, and/or inaccurate data for data processing tasks, among others.

In some embodiments, one or more classifier models are leveraged to improve machine learning provided by the downstream classifier model associated with the aggregation layer for the multi-modal machine learning framework. For example, the plurality of classification scores may be utilized as an optimized training dataset for the classifier model. In some embodiments, the classifier model is trained using the optimized training dataset to enable an optimized classification score (e.g., the aggregated classification score) for a data object. In this manner, the multi-modal machine learning framework provides an automated solution to several technical challenges with traditional classifier models, such as being prone to inaccurately formatted data for a particular machine learning task, model inefficiencies, and/or classification prediction errors, by training the classifier model with an optimized training dataset for a machine learning task based on output provided by two or more other machine learned models. Ultimately, the multi-modal machine learning framework provides a technical improvement to the art of machine learning though a new arrangement of machine learning architectures that integrates different machine learning architectures to provide improved performance and/or accuracy of predictions for classifier model, while overcoming various challenges with traditional machine learning.

In some embodiments, the multi-modal machine learning framework is leveraged to provide a quality assessment of a data object. For example, the quality assessment of a data object may comprise generating a plurality of quality assessment scores for a data object based on content of the data object and a domain knowledge feature set associated with a domain knowledge profile for the data object, training a classifier model such as a tree-based classifier based on the plurality of quality assessment scores to generate an aggregated quality assessment score for the data object, and performing an action such as a computer-based action for the data object based on a comparison between the aggregated quality assessment score and a threshold score.

In one practical example, using a document processing technology domain for illustration, the multi-modal machine learning framework may provide improved machine learning by generating a plurality of quality assessment scores for a document based on content of the document and a feature set associated with a task domain, training a tree-based classifier based on the plurality of quality assessment scores to generate an aggregated quality assessment score for the document, and performing an action for the document based on a comparison between the aggregated quality assessment score and a threshold score.

Examples of technologically advantageous embodiments of the present disclosure comprise improved: (i) improved machine learning systems, (ii) improved performance and/or predictive output for a classifier model, (iii) improved training datasets for a machine learning model, (iv) improved user interfaces and/or data visualizations by optimizing a data object for a rendering of a data visualization via a user interface, and (v) improved transmission of one or more data packets over a network to append machine learning information to digital data, among other aspects of the present disclosure. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

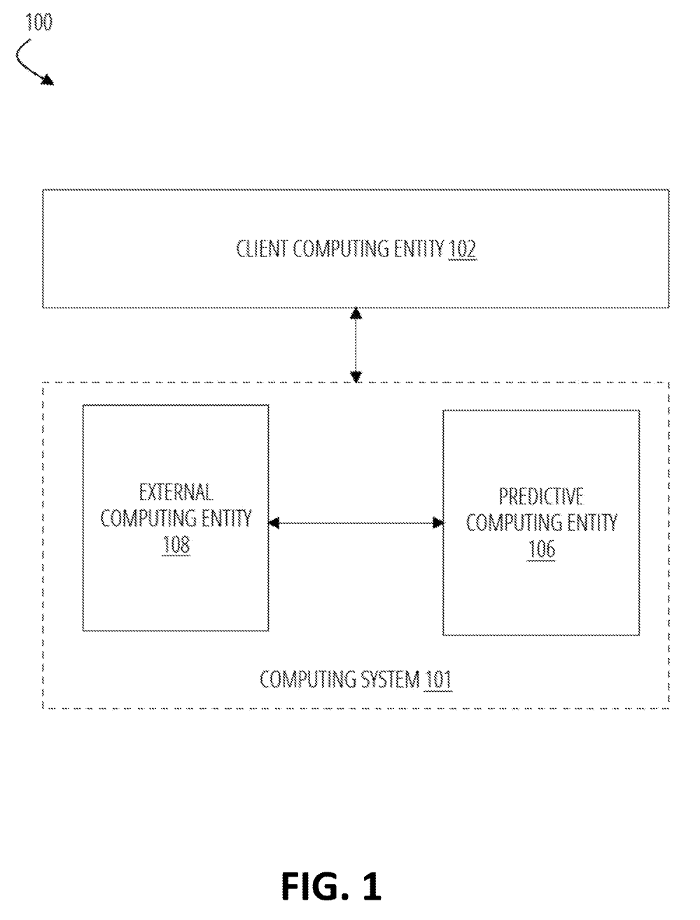

FIG. 1 depicts an example overview of an architecture 100 in accordance with some embodiments of the present disclosure. The architecture 100 comprises a computing system 101 configured to receive a request, such as a user interface request, a computing task request, a machine learning request, a model prompt request, a query, and/or the like, from client computing entities 102, process the request, and provide one or more responses, such as model output, machine learning output, a data visualization, a user interface overlay, one or more graphical elements, and/or the like to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate candidate outputs, candidate output scores, and/or other machine learned outputs. The models may be adapted to a differential request handling engine and/or complementary scoring mechanism that may collectively process a request using data scaling and/or data pre-processing. Some techniques of the present disclosure may adapt traditional models to a cohesive modeling framework for more efficiently handling portions of the request handling process.

In some embodiments, the computing system 101 communicates with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate classifier models in accordance with one or more training and/or inference operations of the present disclosure. In some examples, the external computing entities 108 may be configured to train, implement, use, update, and evaluate classifier models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., request handling, classifier modeling techniques, training techniques, etc.) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as one or more recorded entity cohorts and/or the like, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained model trained and subsequently provided by the one or more external computing entities 108. For example, the one or more external computing entities 108 may be configured to perform one or more training steps/operations of the present disclosure to train a model, as described herein. In such a case, the trained model may be provided to the predictive computing entity 106, which may leverage the trained model to perform one or more inference steps/operations of the present disclosure. In some examples, feedback (e.g., evaluation data, ground truth data) from the use of the model may be received and/or stored by the predictive computing entity 106. In some examples, the feedback may be provided to the one or more external computing entities 108 to continuously train the model over time. In some examples, the feedback may be leveraged by the predictive computing entity 106 to continuously train the model over time. In this manner, the computing system 101 may perform, via one or more combinations of computing entities, one or more prediction, training, and/or any other modeling techniques of the present disclosure.

### A. Example Predictive Computing Entity

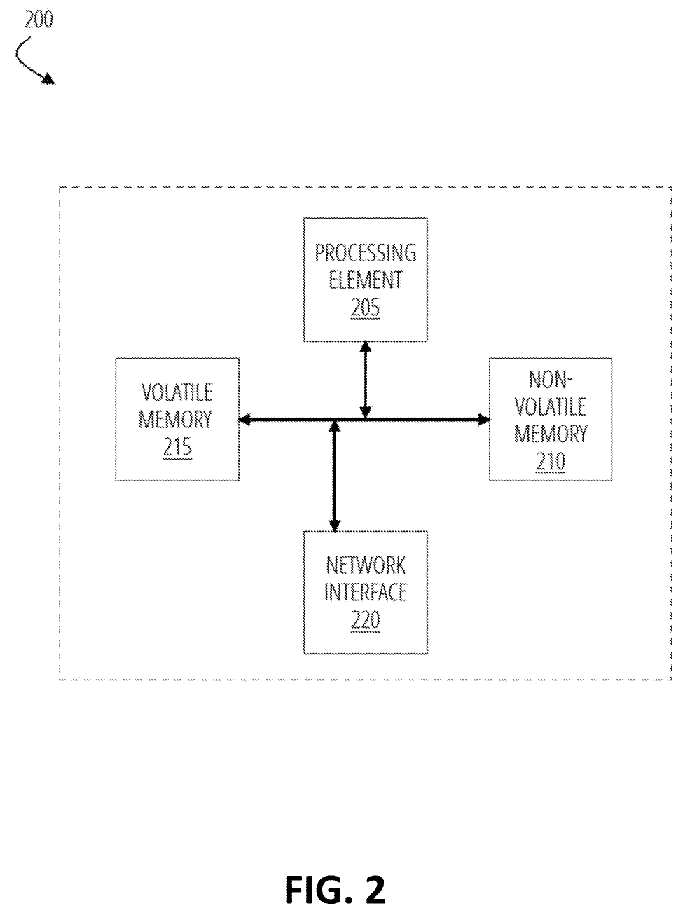

FIG. 2 depicts an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

### B. Example Client Computing Entity

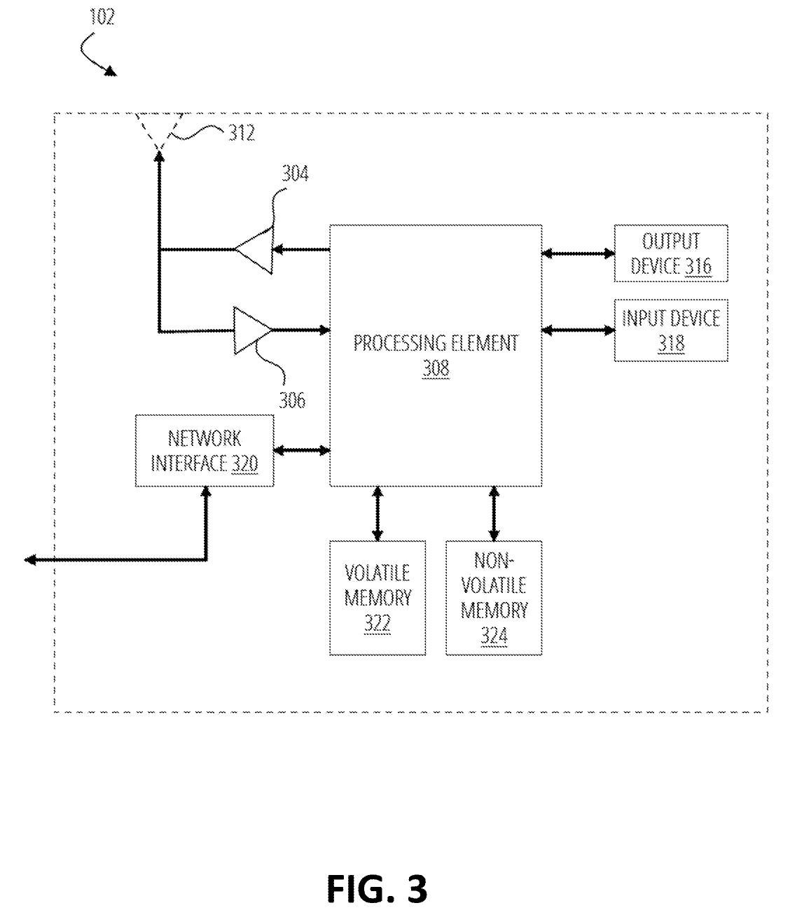

FIG. 3 depicts an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may in addition or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may in addition or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to optimizing machine learning systems by providing a multi-modal machine learning framework that assess quality of a data object to enable improved machine learning via a downstream classifier model. To do so, some embodiments of the present disclosure provide a data processing pipeline that utilizes multi-modal machine learning to generate a plurality of classification scores for a data object to enable improved machine learning for a classifier model. In some embodiments of the present disclosure, unique feature set for the data object may be intelligently generated for a particular data machine learning task to provide a particular classification score of the plurality of classification scores. In some embodiments, the plurality of classification scores may be utilized by the classifier model to provide an aggregated classification score for the data object. This, in turn, enables an improved data processing pipeline integrated with machine learning that directly addresses technical challenges within the realm of traditional data processing techniques, such as not inaccurately formatted data for a particular data processing task (e.g., a particular machine learning task), resource intensive processing and/or reprocessing of data due to inaccurately formatted data, and/or inaccurate data for data processing tasks, among others.

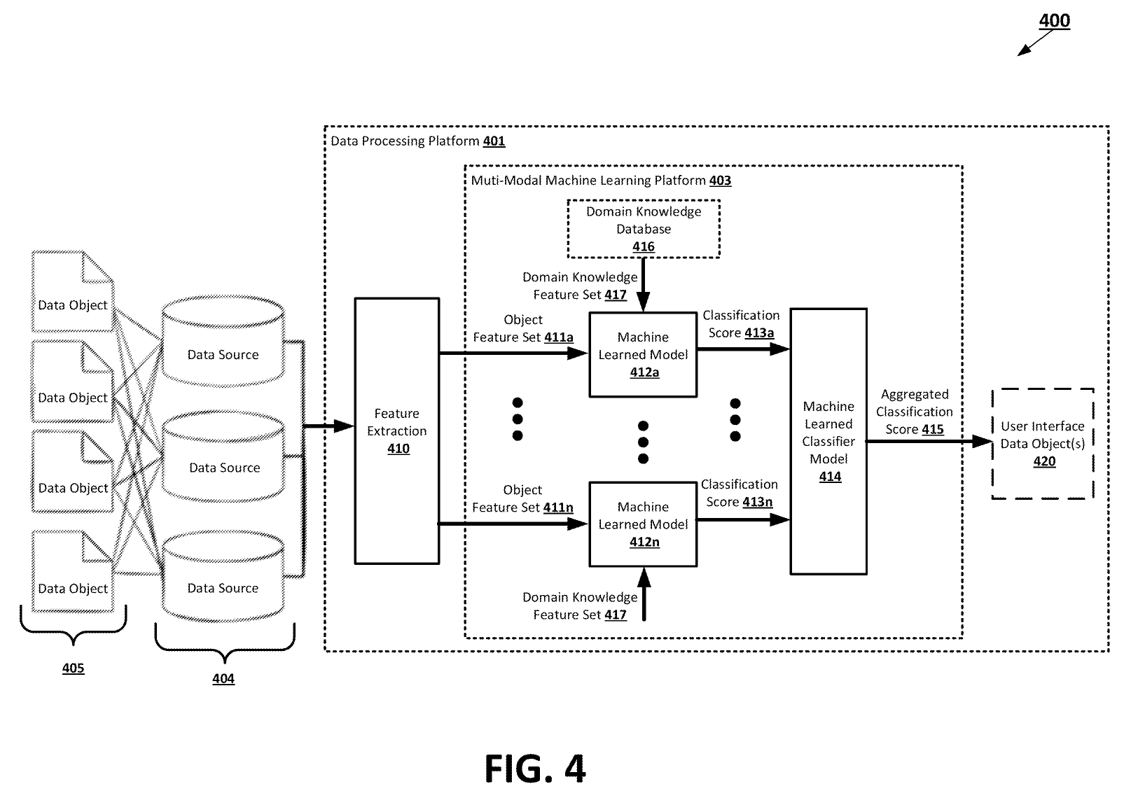

FIG. 4 depicts a dataflow diagram 400 showing example data structures, modules, and/or pipelines for providing a multi-modal machine learning framework in accordance with some embodiments discussed herein. In some embodiments, the dataflow diagram 400 provides the multi-modal machine learning framework to assess quality of a data object to enable improved machine learning via a downstream classifier model. In some embodiments, the dataflow diagram 400 provides the multi-modal machine learning framework to improve transmission of one or more data packets over a network to append machine learning information (e.g., one or more user interface data objects associated with machine learning output of the classifier model) to digital data.

The dataflow diagram 400 comprises a data processing platform 401 and one or more data sources 404. In some embodiments, the one or more data sources 404 are configured as one or more electronic health record data sources. The one or more data sources 404 may store one or more data objects 405. In some embodiments, a third-party data element of the one or more data objects 405 may correspond to text and/or one or more images. In some embodiments, a third-party data element of the one or more data objects 405 may be configured in a particular data format such as, PDF, JSON, XML, FHIR, JPEG, DICOM, PNG, TIFF, BMP, and/or another type of data format. In some embodiments, a third-party data element of the one or more data objects 405 may correspond to at least a portion of a lab report, a clinical note, a medical form, or another type of electronic health record.

The data processing platform 401 comprises feature extraction 410 and a multi-modal machine learning platform 403. In one or more embodiments, the multi-modal machine learning platform 403 comprises a plurality of machine learned models 412a-n and a machine learned classifier model 414. The plurality of machine learned models 412a-n may be associated with a respective type of machine learning task. In one or more embodiments, the data processing platform 401 and/or the multi-modal machine learning platform 403 may correspond to a first-party platform with respect to the one or more data objects 405. For example, the data processing platform 401 and/or the multi-modal machine learning platform 403 may correspond to a first-party platform associated with functionality provided by the computing system 101 (e.g., the predictive computing entity 106) and the one or more data objects 405 may be one or more third-party data objects.

In some embodiments, the computing system 101 may perform the feature extraction 410 to extract one or more features from at least a portion of the one or more data objects 405 from the one or more data sources 404 to facilitate machine learning associated with the multi-modal machine learning platform 403. For example, the computing system 101 may generate respective object feature sets for the plurality of machine learned models 412a-n via the feature extraction 410. In some embodiments, the computing system 101 may aggregate and/or import at least a portion of the one or more data objects 405 from the one or more data sources 404 to enable the feature extraction 410. In some embodiments, the computing system 101 may provide the portion of the one or more data objects 405 in a defined and/or consumable format for one or more machine learning processes associated with the multi-modal machine learning platform 403. In some embodiments, the computing system 101 may utilize Object Character Recognition (OCR) to extract textual information from the one or more data objects 405. In some embodiments, the computing system 101 may transform at least a portion of the one or more data objects 405 into a defined first-party format for the multi-modal machine learning platform 403. The defined first-party format may be configured in accordance with one or more data formatting requirements and/or data feature requirements for a particular machine learned model of the plurality of machine learned models 412a-n.

In some embodiments, the computing system 101 may perform the feature extraction 410 responsive to receiving a processing request associated with a data object of the one or more data objects 405. For example, the computing system 101 may extract a data object of the one or more data objects 405 from the one or more data sources 404 responsive to receiving a processing request associated with a data object of the one or more data objects 405 to enable the feature extraction 410 with respect to the data object. In some embodiments, the computing system 101 may generate a plurality of object feature sets 411a-n for the plurality of machine learned models 412a-n. For example, the computing system 101 may generate, based on the data object, at least a first object feature set (e.g., object feature set 411a) for a first machine learned model (e.g., machine learned model 412a) of the plurality of machine learned models 412a-n and a second object feature set (e.g., object feature set 411n) for a second machine learned model (e.g., machine learned model 412n) of the plurality of machine learned models 412a-n. The first machine learned model of the plurality of machine learned models 412a-n may be associated with a first type of machine learning task and the second machine learned model of the plurality of machine learned models 412a-n may be associated with a second type of machine learning task. However, it is to be appreciated that, in some embodiments, the computing system 101 may generate one or more additional object feature sets for one or more additional machine learned models of the plurality of machine learned models 412a-n. In some embodiments, the plurality of object feature sets 411a-n may comprise an image feature set for the data object, a text feature set for the data object, a data content alignment feature set for the data object, a data object feature set for the data object, and/or one or more types of feature sets that correspond to a machine learning task for a machine learned model of the plurality of machine learned models 402a-n. In addition, or alternatively, the computing system 101 may generate a domain knowledge feature set 417 associated with a domain knowledge profile for the data object. In some embodiments, the domain knowledge profile may be stored in a domain knowledge database 416 comprised in or in communication with the multi-modal machine learning platform 403.

In some embodiments, the domain knowledge database 416 is a data entity that describes a particular domain and/or entity. In some embodiments, the domain knowledge database 416 may comprise a plurality of features corresponding to the particular domain and/or entity. In some embodiments, a domain knowledge profile may comprise a clinical knowledge profile identifying a plurality of clinical features corresponding to a particular clinical domain. In some embodiments, the plurality of features may be distributed across a plurality of different information channels. Each of the features may comprise one or more searchable attributes, such as text attributes that may be searched using keyword matching techniques, source embedding attributes that may be searched using embedding matching techniques, and/or the like. In some embodiments, a domain knowledge datastore refers to a dataset for a domain. For example, a domain knowledge datastore may comprise a comprehensive dataset that aggregates data from a plurality of disparate data sources associated with a domain. In some embodiments, the aggregated data may be stored in one or more different verticals to enable targeted retrieval and ingestion operations for accessing data. For example, the domain knowledge datastore may comprise data that is associated with a plurality of different sub-domains within a domain. In some embodiments, the data may be ingested through one or more different channels tailored to each of the sub-domains.

In some embodiments, the domain knowledge database 416 comprises different sets of data for different domains. For example, in a healthcare domain, the domain knowledge database 416 may comprise a plurality of clinical knowledge data objects that correspond to one or more clinical domain profiles for one or more clinical domains. For example, the domain knowledge database 416 may augment domain profiles with healthcare knowledge, machine learning techniques, and/or the like, such that each feature of a domain profile is searchable using natural language. In some embodiments, the domain knowledge database 416 comprises one or more models, such as the language model, a machine learning embedding model, and/or the like. The machine learning embedding model, for example, may be leveraged to generate a plurality of source embedding attributes to augment the features of the domain knowledge datastore. In some examples, the models may be accessible (e.g., through machine learning service APIs, etc.) to process a query for a clinical domain data object. In some examples, the domain knowledge datastore may comprise, for a healthcare domain, a plurality of clinical domain profiles, comprising clinical domain names, clinical domain types, medical information related to a clinical domain, relevant medical conditions related to a clinical domain, relevant medications related to a clinical domain, possible interactions for combining medications, and/or other miscellaneous information related to a clinical domain.

Based on the plurality of object feature sets 411a-n provided by the feature extraction 410, the multi-modal machine learning platform 403 may perform one or more machine learning processes to generate a plurality of classification scores 413a-n. In some embodiments, the computing system 101 apply the first machine learned model (e.g., machine learned model 412a) to the first object feature set (e.g., object feature set 411a) and the domain knowledge feature set 417 to generate a first classification score (e.g., classification score 413a) for the data object. Additionally, the computing system 101 apply the second machine learned model (e.g., machine learned model 412n) to the second object feature set (e.g., object feature set 411n) and the domain knowledge feature set 417 to generate a second classification score (e.g., classification score 413n) for the data object. In some embodiments, classification score of the plurality of classification scores 413 may be a quality score for the data object. In some embodiments, the plurality of classification scores 413a-n may comprise an image quality classification score for the data object, a text quality classification score for the data object, a data content alignment classification score for the data object, a void data classification score for the data object, and/or one or more types of classification scores associated with a machine learning task for a machine learned model of the plurality of machine learned models 402a-n. In some embodiments, the computing system 101 may generate the data content alignment feature set based on a context categorization classification for the data object. In some embodiments, the computing system 101 may generate the context categorization classification using a machine learned model that is trained with a training dataset that comprises an object feature set for one or more historical data objects. The one or more historical data object may be associated with the data object. In addition or alternatively, the one or more historical data object may be associated with one or more other data objects that are not associated with the data object. In addition or alternatively, the computing system 101 may generate the context categorization classification using a machine learned model that is trained with a training dataset that comprises an object feature set for one or more historical data processing requests and one or more historical data packets associated with the data processing request.

A machine learned model of the plurality of machine learned models 412a-n may be a hardware and/or software architecture having one or more parameters (e.g., coefficient(s), weight(s), biase(s), activation function(s) and/or action function type(s) in examples where the activation function and/or function type is determined as part of training, clustering centroid(s)/medoid(s), partition(s)) determined as a result of training the machine-learned model based at least in part on training hyperparameters and/or structural hyperparameters defining the model’s architecture. In some examples, structural hyperparameter(s) may define component(s) of the model’s architecture and/or their configuration/order, such as the configuration/order specifying which output(s) of one component are provided as input to other component(s); a number, type, and/or configuration of component(s) per layer, a number of layers of the model, a number of input nodes in an input layer of the model, a number of output nodes of an output layer of the model, component dimension (e.g., input size versus output size), temperature, and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., embedding model(s), generative pre-trained transformer(s) (GPT(s))), neural network(s), multi-layer perceptron(s), Kolmogorov-Arnold network(s), clustering algorithm(s), support vector machine(s), etc.

Additional or alternate hyperparameter(s) (i.e., training hyperparameter(s)) may be used as part of training a machine learned model of the plurality of machine learned models 412a-n. In some examples, the training hyperparameter(s), in addition to the training data and/or input data, may affect determining the parameter(s) of a machine learned model of the plurality of machine learned models 412a-n. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like KANs where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate optimization algorithm type (e.g., gradient descent, adaptive, stochastic) used to determine an alteration to one or more parameters of one or more components of a machine learned model of the plurality of machine learned models 412a-n to reduce the loss determined by the loss function, and/or the like. In some examples, the structural hyperparameters and/or the training hyperparameters may be determined by a hyperparameter optimization algorithm or based on user input, such as a software component written by a user or generated by a machine-learned model. A machine learned model of the plurality of machine learned models 412a-n may comprise any type of model configured, trained, and/or the like to generate a classification score. A machine learned model of the plurality of machine learned models 412a-n may comprise one or more of any type of machine learned model comprising one or more supervised, unsupervised, semi-supervised, and/or reinforcement learning models. In some embodiments, a machine learned model of the plurality of machine learned models 412a-n may comprise a single machine-learned model or multiple machine-learned model models configured to perform one or more different stages of a prediction process.

A machine learned model of the plurality of machine learned models 412a-n may be trained using a training dataset comprising a feature set and/or a label set. In some embodiments, a machine learned model of the plurality of machine learned models 412a-n is a supervised machine learned model that is pre-trained using one or more supervisory and/or semi-supervised training techniques based on a training dataset, such as backpropagation of errors, and/or the like. In some examples, the labels may comprise partition(s), centroid(s) indicated by a user, class(es), k for use in supervised clustering algorithm training, a ground truth value, a ground truth classification, and/or the like. In an example where a machine learned model of the plurality of machine learned models 412a-n is a semi-supervised machine-learned model, a training dataset may comprise previous input(s) to and/or previous output(s) generated by a machine learned model of the plurality of machine learned models 412a-n or another machine-learned model. A machine learned model of the plurality of machine learned models 412a-n may be trained based at least in part on providing a first training input of the set of training inputs to the machine learned model, determining an output by the machine learned model, determining a difference between the output and a first training output of the set of training outputs, determining a loss by a loss function based at least in part on the difference, and altering one or more parameters of the machine learned to reduce the loss (e.g., using a loss optimization algorithm, such as gradient descent). In some examples, this process may be iteratively repeated for up to all of the inputs of the set of training inputs, respectively.

Based on the plurality of classification scores 413a-n provided by the plurality of machine learned models 412a-n, the multi-modal machine learning platform 403 may additionally perform one or more downstream machine learning processes to generate an aggregated classification score 415. In some embodiments, the computing system 101 may apply the machine learned classifier model 414 to the plurality of classification scores 413a-n to generate the aggregated classification score 415. For example, the computing system 101 may generate, using the machine learned classifier model 414, the aggregated classification score 415 for the data object based at least on the first classification score (e.g., classification score 413a) and the second classification score (e.g., classification score 413n). In some embodiments, the computing system 101 may apply the machine learned classifier model 414 to an image quality classification score for the data object, a text quality classification score for the data object, a data content alignment classification score for the data object, a void data classification score for the data object, and/or one or more types of classification scores associated with a machine learning task for a machine learned model of the plurality of machine learned models 402a-n. As such, the aggregated classification score 415 for the data object may be a multi-modality quality assessment score that objectively quantifies quality of the data object in multiple dimensions such as image quality, text quality, availability of content, interpretability of content, and/or alignment of content of the data object.

The machine learned classifier model 414 may be a hardware and/or software architecture having one or more parameters (e.g., coefficient(s), weight(s), biase(s), activation function(s) and/or action function type(s) in examples where the activation function and/or function type is determined as part of training, clustering centroid(s)/medoid(s), partition(s)) determined as a result of training the machine-learned model based at least in part on training hyperparameters and/or structural hyperparameters defining the model’s architecture. In some examples, structural hyperparameter(s) may define component(s) of the model’s architecture and/or their configuration/order, such as the configuration/order specifying which output(s) of one component are provided as input to other component(s); a number, type, and/or configuration of component(s) per layer, a number of layers of the model, a number of input nodes in an input layer of the model, a number of output nodes of an output layer of the model, component dimension (e.g., input size versus output size), temperature, and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., embedding model(s), generative pre-trained transformer(s) (GPT(s))), neural network(s), multi-layer perceptron(s), Kolmogorov-Arnold network(s), clustering algorithm(s), support vector machine(s), etc. In some embodiments, the machine learned classifier model 414 is a tree-based classifier (e.g., a decision tree classifier).

Additional or alternate hyperparameter(s) (i.e., training hyperparameter(s)) may be used as part of training the machine learned classifier model 414. In some examples, the training hyperparameter(s), in addition to the training data and/or input data, may affect determining the parameter(s) of the machine learned classifier model 414. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like KANs where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate optimization algorithm type (e.g., gradient descent, adaptive, stochastic) used to determine an alteration to one or more parameters of one or more components of the machine learned classifier model 414 to reduce the loss determined by the loss function, and/or the like. In some examples, the structural hyperparameters and/or the training hyperparameters may be determined by a hyperparameter optimization algorithm or based on user input, such as a software component written by a user or generated by a machine-learned model. The machine learned classifier model 414 may comprise any type of model configured, trained, and/or the like to generate an aggregated classification score. The machine learned classifier model 414 may comprise one or more of any type of machine learned model comprising one or more supervised, unsupervised, semi-supervised, and/or reinforcement learning models. In some embodiments, the machine learned classifier model 414 may comprise a single machine-learned model or multiple machine-learned model models configured to perform one or more different stages of a prediction process.

The machine learned classifier model 414 may be trained using a training dataset comprising a feature set and/or a label set. In some embodiments, the machine learned classifier model 414 is a supervised machine learned model that is pre-trained using one or more supervisory and/or semi-supervised training techniques based on a training dataset, such as backpropagation of errors, and/or the like. In some examples, the labels may comprise partition(s), centroid(s) indicated by a user, class(es), k for use in supervised clustering algorithm training, a ground truth value, a ground truth classification, and/or the like. In an example where the machine learned classifier model 414 is a semi-supervised machine-learned model, a training dataset may comprise previous input(s) to and/or previous output(s) generated by the machine learned classifier model 414 or another machine-learned model. The machine learned classifier model 414 may be trained based at least in part on providing a first training input of the set of training inputs to the machine learned classifier model 414, determining an output by the machine learned classifier model 414, determining a difference between the output and a first training output of the set of training outputs, determining a loss by a loss function based at least in part on the difference, and altering one or more parameters of the machine learned classifier model 414 to reduce the loss (e.g., using a loss optimization algorithm, such as gradient descent). In some examples, this process may be iteratively repeated for up to all of the inputs of the set of training inputs, respectively.

The computing system 101 may utilize the aggregated classification score 415 to initiate the performance of one or more prediction-based actions. In some embodiments, the computing system 101 may generate one or more user interface data objects 420 associated with the aggregated classification score 415. In some embodiments, the computing system 101 may transmit, in response to, one or more data packets that comprise the one or more user interface data objects 420 associated with the aggregated classification score 415. In some embodiments, the one or more user interface data objects 420 may comprise one or more interactive graphical elements configured based on the aggregated classification score 415. In some embodiments, a rendering of the one or more user interface data objects 420 may be initiated via a user interface.

In some embodiments, the one or more prediction-based actions may be performed based on a comparison between the aggregated classification score 415 and a threshold score. The threshold score may be determined based on historical data. In some embodiments, if the aggregated classification score 415 is less than the threshold score, the document may be rejected and a provider may be notified. In some embodiments, if the aggregated classification score is less than the threshold score, the one or more prediction-based actions may be withheld. In some embodiments, if the aggregated classification score is less than the threshold score, a notification may be provided to a user interface via the one or more user interface data objects 420 with an identified issue for the data object based on the aggregated classification score 415. In some embodiments, if the aggregated classification score is above the threshold score, the one or more prediction-based actions may be executed. In some embodiments, if the aggregated classification score is above the threshold score, the data object may be accepted and provided to a downstream system associated with one or more computing tasks. In some embodiments, if the data object is a text only data object, the data object may be rejected if the aggregated classification score 415 is lower than a predetermined threshold. In some embodiments, if the data object is an image only data object, the data object may be rejected if the aggregated classification score 415 is zero (e.g., none of the images in the data object are deemed to have good quality).

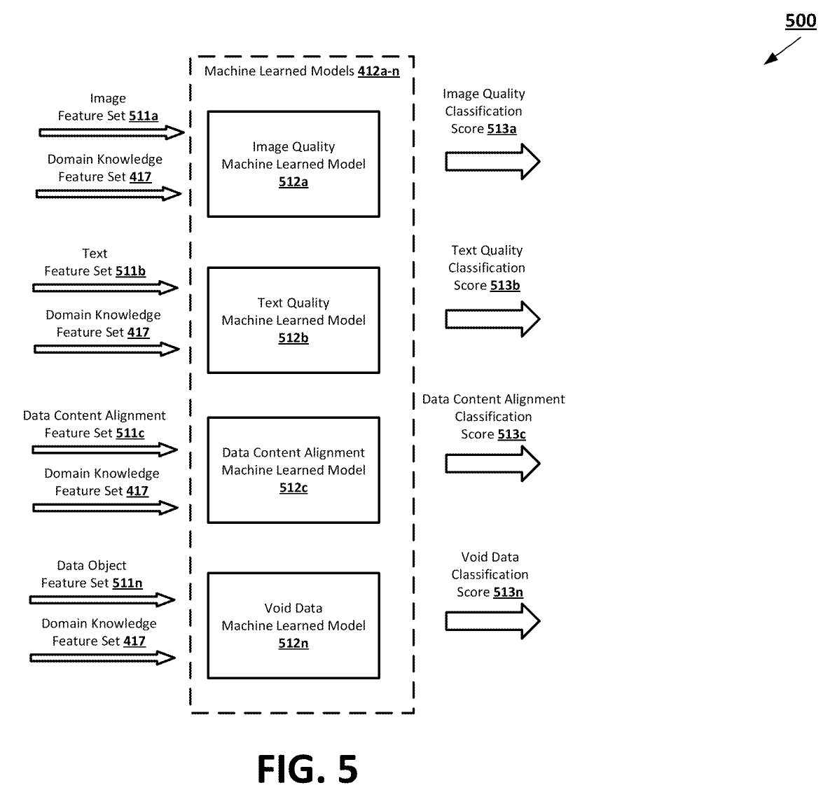

FIG. 5 depicts a dataflow diagram 500 showing example data structures, modules, and/or pipelines for enabling a multi-modal machine learning framework in accordance with some embodiments discussed herein. In some embodiments, the dataflow diagram 500 enables improved machine learning via a downstream classifier model. In some embodiments, the dataflow diagram 500 enables improved training, execution, performance, and/or predictive output of a downstream classifier model.

The dataflow diagram 500 comprises the plurality of machine learned models 412a-n. In some embodiments, the plurality of machine learned models 412a-n comprise an image quality machine learned model 512a, a text quality machine learned model 512b, a data content alignment machine learned model 512c, and/or a void data machine learned model 512n. The image quality machine learned model 512a may be configured to determine quality of one or more images in the data object of the one or more data objects 405. In some embodiments, the image quality machine learned model 512a may be a classifier model configured to classify an image as a good quality image or a poor quality image. In some embodiments, the image quality machine learned model 512a may be configured to classify an image as a good quality image or a poor quality image based on scanning quality, image distortions, and/or one or more other types of image quality parameters associated with the image. In some embodiments, the image quality machine learned model 512a may be trained based on one or more image features sets associated with one or more historical data objects. Additionally, the image quality machine learned model 512a may be trained based on one or more domain knowledge features sets associated with the one or more historical data objects. In some embodiments, the image quality machine learned model 512a may be trained based on one or more types of images such as color photographs, x-rays, computed tomography (CT) scans, magnetic resonance imaging (MRI) images, DICOM image slices, PNG images, JPEG images, and/or one or more other types of images. In some embodiments, a trained version of the image quality machine learned model 512a may be applied to both an image feature set 511a for the data object and the domain knowledge feature set 417 to generate an image quality classification score 513a for the data object. In some embodiments, the image quality classification score 513a may be based on respective classifications for respective images of the data object.

The text quality machine learned model 512b may be configured to determine quality of one or more text segments in the data object of the one or more data objects 405. In some embodiments, the text quality machine learned model 512b may be a classifier model configured to classify a text segment as a good quality text or a poor quality text. In some embodiments, the text quality machine learned model 512b may be configured to classify a text segment as a good quality text or a poor quality text based on scanning quality, image distortions for an image that comprises text, and/or one or more other types of text quality parameters associated with the text segment. In some embodiments, the text quality machine learned model 512b may be configured to classify a text segment as a good quality text or a poor quality text based on results of an OCR operation associated with the text segment. In some embodiments, the text quality machine learned model 512b may be trained based on one or more text features sets associated with one or more historical data objects. Additionally, the text quality machine learned model 512b may be trained based on one or more domain knowledge features sets associated with the one or more historical data objects. In some embodiments, the text quality machine learned model 512b may be trained based on one more types of text segments. A text segment may be a data construct that describes a sequence of words within a data object. In some embodiments, a text segment corresponds to a sentence, text sequence, clinical note line, or other text segment of a data object. For example, a text segment may be a medical text sequence within a data object. In some embodiments, a trained version of the text quality machine learned model 512b may be applied to both a text feature set 511b for the data object and the domain knowledge feature set 417 to generate a text quality classification score 513b for the data object. In some embodiments, the image quality classification score 513a may be based on respective classifications for respective text segments of the data object.

The data content alignment machine learned model 512c may be configured to determine alignment of content in the data object of the one or more data objects 405 as compared to expected content of the data object. In some embodiments, the data content alignment machine learned model 512c may be a classifier model configured to classify content in the data object as being aligned or not being aligned as compared to expected content of the data object. For example, the data content alignment machine learned model 512c may be configured to classify content in the data object as being aligned or not being aligned as compared to an expected context categorization classification for the data object and/or expected information for a particular domain task. In some embodiments, the expected context categorization classification may be associated with a set of predefined data type codes for data objects. In some embodiments, the particular domain task corresponds to a condition of interest (e.g., a medical condition of interest) for a patient. In some embodiments, the data content alignment machine learned model 512c may be trained based on one or more data content alignment features sets associated with one or more historical data objects. Additionally, the data content alignment machine learned model 512c may be trained based on one or more domain knowledge features sets associated with the one or more historical data objects. In some embodiments, the data content alignment machine learned model 512c may be trained based on one more types of content alignments. In some embodiments, a trained version of the data content alignment machine learned model 512c may be applied to both a data content alignment feature set 511c for the data object and the domain knowledge feature set 417 to generate a data content alignment classification score 513c for the data object. In some embodiments, the data content alignment machine learned model 512c may be based on respective classifications associated with respective context categorization classifications of the data object.

The void data machine learned model 512n may be configured to determine whether content of the data object of the one or more data objects 405 is void. In some embodiments, the void data machine learned model 512n may be a classifier model configured to classify content in the data object as being void or not void. For example, the void data machine learned model 512n may be configured to classify content in the data object as being void of text and/or imagery. In some embodiments, the void data machine learned model 512n may be trained based on one or more data object features sets associated with one or more historical data objects. Additionally, the void data machine learned model 512n may be trained based on one or more domain knowledge features sets associated with the one or more historical data objects. In some embodiments, the void data machine learned model 512n may be trained based on one more historical data objects that are deemed void of text and/or imagery. In some embodiments, a trained version of the void data machine learned model 512n may be applied to both an object feature set 511n for the data object and the domain knowledge feature set 417 to generate a void data classification score 513n for the data object.

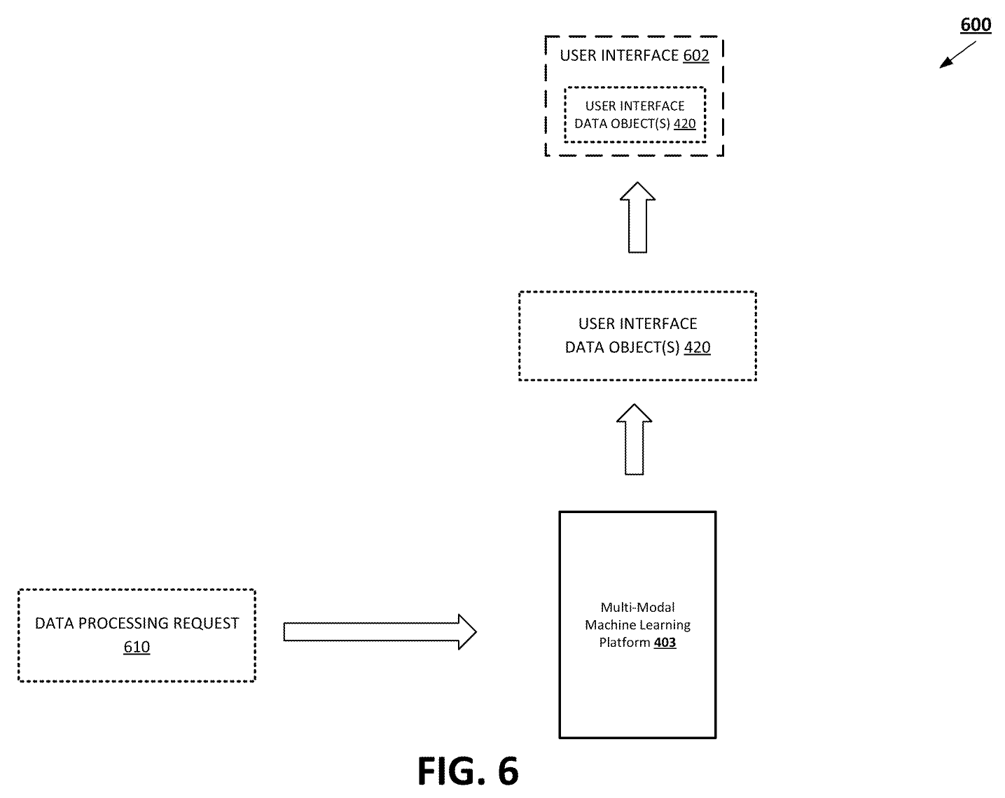

FIG. 6 depicts an interactive visualization system 600 showing example devices, systems, engines, data structures, and/or processes for generating one or more user interface elements for rendering via a user interface in accordance with some embodiments discussed herein. In some embodiments, the interactive visualization system 600 may enable real-time configuration of a user interface based on the aggregated classification score 415. The interactive visualization system 600 may further enable a user to consume visual data and/or related insights associated with the aggregated classification score 415 in an interactive manner, where the visual data is tailored based on the aggregated classification score 415.

In some embodiments, the interactive visualization system 600 comprises a user interface 602 of a user device. The user interface 602 may be an electronic interface for a web page, a mobile application, an electronic portal, a chatbot (e.g., an LLM-based chatbot), and/or the like. In some embodiments, a data processing request 610 may be received. In some embodiments, the data processing request 610 may be automatically generated by a processor to initiate processing of a data object stored in the one or more data sources 404. In some embodiments, the data processing request 610 is associated with the user interface 602 and/or may be generated by the user device. For example, the data processing request 610 may be a user interface request. In some embodiments, the data processing request 610 may be a query provided to a large language model. In some embodiments, the user device may transmit the data processing request 610 to the computing system 101 via a network. The network may be configured based on one or more wired and/or wireless communication protocols. For example, the network may provide communication executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 106 may be configured to communicate via wireless external communication using any of a variety of protocols, as further disclosed herein.

In some embodiments, the data processing request 610 comprises character-level text input associated with a structured and/or natural language sequence of text (e.g., one or more alphanumeric characters, symbols, etc.). In some examples, the character-level text input may comprise user input, such as text input and/or text generated from one or more audio, tactile, and/or like inputs related to the user interface 602. In some examples, the character-level text input may comprise a natural language sequence of text provided via the user interface 602. In some examples, character-level text input may comprise a natural language sequence of text that expresses a question, preference, and/or the like. In addition or alternatively, the character-level text input may indicate a computing task domain associated and/or a data object identifier associated with a data object.

In some embodiments, the data processing request 610 may comprise or otherwise be associated with one or more request attributes such as a location attribute (e.g., a GPS position, a latitude/longitude, etc.) and/or the like. For example, the one or more request attributes may comprise user location data. The user location data may comprise a real-time location approximation associated with the user device, data (e.g., a GPS position, a latitude/longitude, etc.) provided by a location module of the user device, data associated with a network connection (e.g., a 5G connection, an internet protocol (IP) address, etc.) associated with the user device, data based on location text input provided by a user via the user interface 602, a geofence location associated with the user device, and/or other location data associated with the user device.

In some embodiments, the user location data comprises location information (e.g., a GPS position, a latitude/longitude, an address, a geofence location, etc.) associated with a user device and/or a user identifier. In some embodiments, the user location data is based on a location module of the user device. The location module may be adapted to acquire, for example, latitude, longitude, altitude, geocode, course, direction, heading, speed, UTC, date, and/or various other information/data. In one embodiment, the location module may acquire data, such as ephemeris data, by identifying the number of satellites in view and the relative positions of those satellites (e.g., using GPS). The satellites may be a variety of different satellites, comprising LEO satellite systems, DOD satellite systems, the European Union Galileo positioning systems, the Chinese Compass navigation systems, Indian Regional Navigational satellite systems, and/or the like. This data may be collected using a variety of coordinate systems, such as the DD; DMS; UTM; UPS coordinate systems; and/or the like. Alternatively, the location information/data may be determined by triangulating a position of the user device in connection with a variety of other systems, comprising cellular towers, Wi-Fi access points, and/or the like. In some embodiments, the location module may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, BLE transmitters, NFC transmitters, and/or the like.

In some embodiments, the computing system 101 receives the data processing request 610 via the network. In some embodiments, the computing system 101 utilizes the multi-modal machine learning platform 403 to generate one or more user interface data objects 420. In some embodiments, responsive to the data processing request 610, the computing system 101 may initiate presentation of the one or more user interface data objects 420 via the user interface 602. For example, the computing system 101 may initiate presentation of the one or more user interface data objects 420 in real time or at least approximately in real time as compared to the data processing request 610 being generated via the user interface 602 and/or received by the computing system 101. In some embodiments, the one or more user interface data objects 420 may comprise a query response for the data processing request 610.

In some embodiments, the one or more user interface data objects 420 may be formatted to provide a visualization and/or human interpretation of data via the user interface 602. In some embodiments, the one or more user interface data objects 420 and/or one or more computer-executable instructions associated therewith may be formatted for transmission via the network. For example, the one or more user interface data objects 420 may be formatted for transmission via an API, a communication channel, a communication interface, or combinations thereof. In one or more embodiments, the one or more user interface data objects 420 may be interacted with via the user interface 602.

In some embodiments, the computing system 101 transmits the one or more user interface data objects 420 to the user device via the network. In some embodiments, the computing system 101 initiates a rendering of the one or more user interface data objects 420 via the user interface 602 of the user device. In some embodiments, the one or more user interface data objects 420 may be correlated to one or more other user interface elements displayed via the user interface 602. In some embodiments, an arrangement of the one or more user interface data objects 420 may be optimally organized and/or presented via the user interface 602 to reduce a number of computing resources utilized by the user device for interacting with the one or more user interface data objects 420. In some embodiments, a visual scale of the user interface 602 may be modified based on the one or more user interface data objects 420. As such, an efficient and cost-effective user interface visualization may be provided for the user device by utilizing the computing system 101.

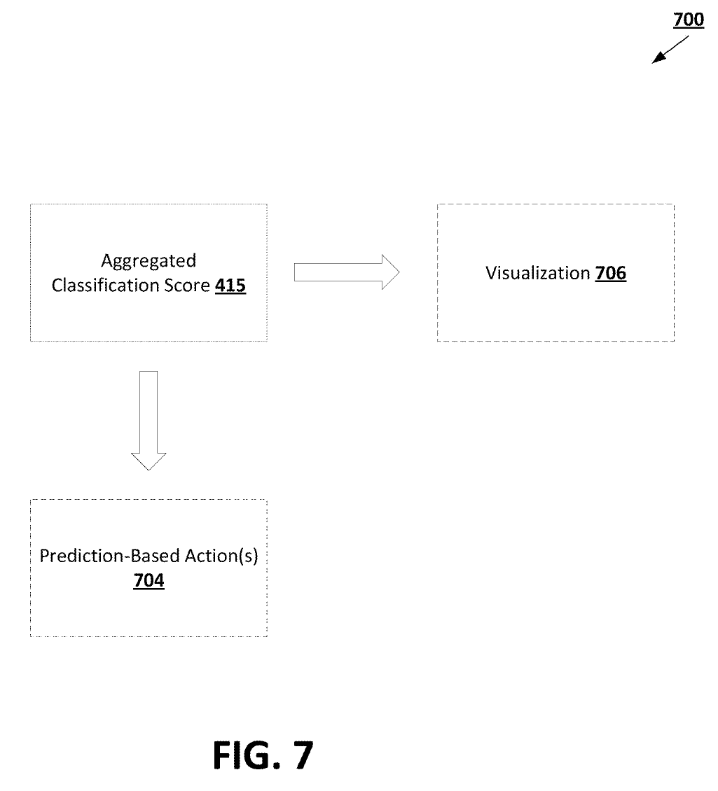

FIG. 7 depicts an example system 700 for providing prediction-based actions and/or visualizations, in accordance with one or more embodiments of the present disclosure. In some embodiments, one or more prediction-based actions 704 are performed based on the aggregated classification score 415. For example, the performance of the one or more prediction-based actions 704 may be initiated based on the aggregated classification score 415. However, it is to be appreciated that, in some embodiments, the one or more prediction-based actions 704 are performed based on one or more other output as disclosed herein such as the one or more user interface data objects 420. In some embodiments, the performance of the one or more prediction-based actions 704 may be initiated via an optimization model. For example, in some embodiments, the performance of the one or more prediction-based actions 704 may be initiated via a predictive machine learned model that is trained for a different predictive task than the machine learned classifier model 414. In some embodiments, data associated with the aggregated classification score 415 may be stored in a storage system, such as the volatile memory 215, the non-volatile memory 210, the volatile memory 322, or the non-volatile memory 324. The data stored in the storage system may be employed for providing user interface rendering, user interface data objects (e.g., the one or more user interface data objects), data packets that comprise user interface data objects, graphical visualizations, machine learning, recommendations, reporting, decision-making purposes, operations management, healthcare management, configuring a manufacturing device, and/or other purposes. In certain embodiments, the data stored in the storage system may be employed to provide one or more insights to assist with healthcare decision making processes, such as, medical decisions for a patient. In addition or alternatively, one or more machine learned models may be retrained based on one or more features associated with the aggregated classification score 415. For example, one or more relationships between features mapped in the machine learned classifier model 414 and/or one or more machine learned models of the plurality of machine learned models 412a-n may be adjusted (e.g., refitted, tuned, etc.) based on data associated with the aggregated classification score 415. In another example, cross-validation, hyperparameter optimization, and/or regularization associated with the machine learned classifier model 414 and/or one or more machine learned models of the plurality of machine learned models 412a-n may be adjusted based on one or more features associated with the aggregated classification score 415. In addition or alternatively, a visualization 706 may be generated based on the aggregated classification score 415. The visualization 706 may comprise and/or be configured based on, for example, one or more user interface data objects (e.g., the one or more user interface data objects) for a user interface based on the aggregated classification score 415.

In some embodiments, the one or more prediction-based actions 704 may comprise automated user interface actions, automated alerts, automated instructions to user devices, and/or automated adjustments to allocations of computing resources. Further, the one or more prediction-based actions 704 may comprise automated physician notification actions, automated patient notification actions, automated appointment scheduling actions, automated prescription recommendation actions, automated record updating actions, automated datastore updating actions, automated workforce management operational management actions, automated server load balancing actions, automated resource allocation actions, automated pricing actions, automated plan update actions, automated alert generation actions, generating one or more electronic communications, and/or the like. The one or more prediction-based actions 704 may further comprise displaying visual renderings of the aforementioned examples of prediction-based actions in addition to values, charts, and representations associated with the one or more policy scores and the prediction output using a prediction output user interface such as the visualization 706.

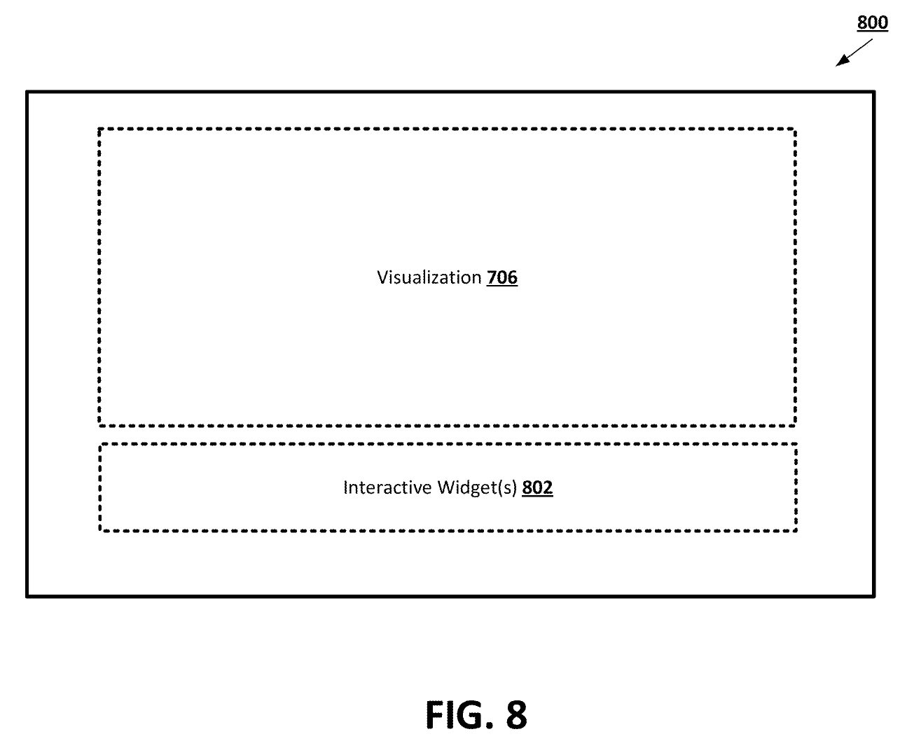

FIG. 8 depicts an example user interface 800, in accordance with one or more embodiments of the present disclosure. In one or more embodiments, the user interface 800 is, for example, an electronic interface (e.g., a graphical user interface) of the client computing entity 102. In some embodiments, the user interface 800 corresponds to the user interface 602. In some embodiments, the user interface 800 may be provided via the output device 316 of the client computing entity 102. In some embodiments, the user interface 800 is an electronic interface that provides a display and/or a visualization to a user via a user computing device. In some embodiments, the user interface 800 provides a GUI and/or associated GUI wizard (e.g., executable code configured to control a functionality of GUI) that provides one or more interactive interface screens, representations, and/or widgets for interacting with a user. The user interface 800 may be configured to provide, for display to a user, a visualization associated with the aggregated classification score 415. For example, the user interface 800 may be configured to provide the one or more user interface data objects via the visualization 706. In some embodiments, the user interface 800 may optimally configure and/or modify a visual scale of the visualization 706 based on the one or more user interface data objects. In some embodiments, the user interface 800 is configured to render an interactive visualization associated with the aggregated classification score 415. For example, the user interface 800 may be configured to render the visualization 706. In addition or alternatively, the user interface 800 may be configured to render one or more interactive widgets 802.

In various embodiments, the visualization 706 may provide an interactive visualization associated with the aggregated classification score 415 to initiate a rendering of a script and/or execution of one or more instruction sets associated with a visualization. In some embodiments, the one or more interactive widgets 802 may be configured to receive user input to generate a request (e.g., the data processing request 610) for initiating data processing for a data object. In various embodiments, the user interface 800 may be configured as a web portal interface (e.g., a medical provider portal, etc.) for managing data insights, allocation of resources, and/or a manufacturing device. In some embodiments, a user interaction with a particular widget of the one or more interactive widgets 802 may result in rendering of a new interactive widget and/or a new user interface. In some embodiments, the visualization 706 rendered via the user interface 800 may provide a rendering of a visualization associated with training dataset and/or configuration parameters during training and/or configuration of the machine learned classifier model 414 and/or one or more machine learned models of the plurality of machine learned models 412a-n. In some embodiments, one or more portions of the machine learned classifier model 414 and/or one or more machine learned models of the plurality of machine learned models 412a-n may be configured based on a user interaction with respect to the visualization 706 and/or the one or more interactive widgets 802.

In some embodiments, the visualization 706 is configured to render the one or more user interface data objects 420 associated with the aggregated classification score 415. A user interface data object may be a formatted version of visual data to provide a visualization and/or human interpretation of data via the user interface 800. In some embodiments, the one or more user interface data objects 420 are formatted for transmission via a network, an API, a communication channel, a communication interface, the like, or combinations thereof. In some embodiments, the one or more user interface data objects 420 are configured to improve transmission of one or more data packets over a network to append machine learning information (e.g., the one or more user interface data objects 420) to digital data via the visualization 706 and/or the one or more interactive widgets 802. In some embodiments, the one or more user interface data objects 420 comprise one or more graphical elements and/or one or more textual elements that may be selectable and/or otherwise interacted with via the user interface 800.

In some embodiments, the user interface 800 is configured to provide visual data for a script associated with one or more prompts with respect to the user interface 800. In some embodiments, a visualization associated with a script may be arranged relative to the one or more interactive widgets 802 to enable user input with respect to the script. In some embodiments, the one or more interactive widgets 802 enable a real-time workflow associated with a script. In this manner, the user interface 800 may provide an interface between a user and a platform that enables a user to selectively a contribute to the real-time workflow associated with a script. In some embodiments, the user interface 800 is configured to provide interaction with a large language model via one or more prompts and/or prompt responses provided via the one or more interactive widgets 802.

The user interface 800 may be specially configured to reduce the time, burden, and processing resources traditionally expended to ingest data from a plurality of data sources and/or the machine learned classifier model 414. To do so, the user interface 800 may arrange an interactive representation (e.g., the one or more user interface data objects 420) relative to an optimal configuration of visual representations and/or corresponding interactive widgets 802. The interactive representation and/or the one or more interactive widgets 802 may be arranged to accommodate small screen sizes, such as mobile devices, laptops, etc., without reducing the efficacy of a reviewing process. This, in turn, allows the performance of traditionally complex data matching operations from a client device with small form factors.

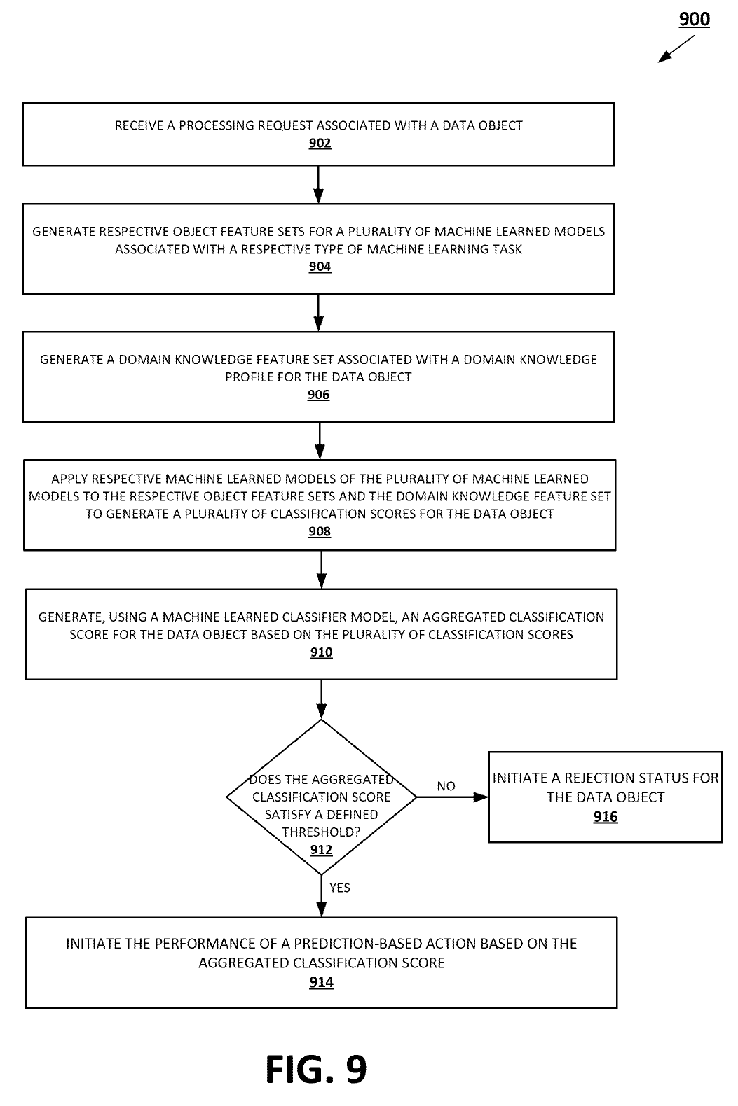

FIG. 9 depicts a flowchart diagram of an example process 900 for providing a multi-modal machine learning framework for generating an aggregated classification score for a data object in accordance with some embodiments discussed herein. The process 900 may be executed by one or more computing devices, entities, and/or systems (e.g., the computing system 101 and/or the predictive computing entity 106) described herein. For example, via the various steps/operations of the process 900, the computing system 101 may leverage improved data processing, modeling, feature selection, and/or classification techniques to optimize a machine learned document classifier model. By doing so, the process 900 enables improved machine learning actions related to a defined machine learning task, while ensuring data quality and/or optimized computing resources in view of various data processing and/or modeling rules.

FIG. 9 illustrates an example process 900 for explanatory purposes. Although the example process 900 depicts a particular sequence of steps/operations, the sequence may be altered without departing from the scope of the present disclosure. For example, some of the steps/operations depicted may be performed in parallel or in a different sequence that does not materially impact the function of the process 900. In other examples, different components of an example device or system that implements the process 900 may perform functions at substantially the same time or in a specific sequence.

In some embodiments, the process 900 comprises, at step/operation 902, receiving a processing request associated with a data object.

In some embodiments, the process 900 comprises, at step/operation 904, generating respective object feature sets for a plurality of machine learned models associated with a respective type of machine learning task. For example, the computing system 101 may generate, based on the data object, at least (i) a first object feature set for a first machine learned model associated with a first type of machine learning task and (ii) a second object feature set for a second machine learned model associated with a second type of machine learning task.

In some embodiments, the process 900 comprises, at step/operation 906, generating a domain knowledge feature set associated with a domain knowledge profile for the data object.

In some embodiments, the process 900 comprises, at step/operation 908, applying respective machine learned models of the plurality of machine learned models to the respective object feature sets and the domain knowledge feature set to generate a plurality of classification scores for the data object. For example, the computing system 101 may apply the first machine learned model to the first object feature set and the domain knowledge feature set to generate a first classification score for the data object. Additionally, the computing system 101 may apply the second machine learned model to the second object feature set and the domain knowledge feature set to generate a second classification score for the data object.

In some embodiments, the process 900 comprises, at step/operation 910, generating, using a machine learned classifier model, an aggregated classification score for the data object based on the plurality of classification scores. For example, the computing system 101 may generate, using a machine learned classifier model, an aggregated classification score for the data object based on the first classification score and the second classification score.

In some embodiments, the first object feature set is an image feature set for the data object, the first classification score generated by the first machine learned model is an image quality classification score for the data object, and the computing system 101 may generate, using the machine learned classifier model, the aggregated classification score for the data object based on the image quality classification score and the second classification score.

In some embodiments, the first object feature set is a data content alignment feature set for the data object, the first classification score generated by the first machine learned model is a data content alignment classification score for the data object, and the computing system 101 may generate the data content alignment feature set based on a context categorization classification for the data object. In some embodiments, the computing system 101 may generate, using the machine learned classifier model, the aggregated classification score for the data object based on the data content alignment classification score and the second classification score. In some embodiments, the computing system 101 may generate the context categorization classification using a third machine learned model that is trained with a training dataset that comprises a third object feature set for one or more historical data objects. In some embodiments, the computing system 101 may generate the context categorization classification using a third machine learned model that is trained with a training dataset that comprises a third object feature set for one or more historical data processing requests and one or more historical data packets associated with the data processing request.

In some embodiments, the first classification score generated by the first machine learned model is a void data classification score for the data object, and the computing system 101 may generate, using the machine learned classifier model, the aggregated classification score for the data object based on the void data classification score and the second classification score.

In some embodiments, the first object feature set is a text feature set for the data object, the second object feature set is an image feature set for the data object, the first classification score generated by the first machine learned model is a text quality classification score for the data object, the second classification score generated by the second machine learned model is an image quality classification score for the data object, and the computing system 101 may generate, using the machine learned classifier model, the aggregated classification score for the data object based on the text quality classification score and the image quality classification score.

In some embodiments, the computing system 101 may generate, based on the data object, a third object feature set for a third machine learned model associated with a third type of machine learning task. In some embodiments, the computing system 101 may apply, by the one or more processors, the third machine learned model to the third object feature set and the domain knowledge feature set to generate a third classification score for the data object. In some embodiments, the computing system 101 may generate, using the machine learned classifier model, the aggregated classification score based on the first classification score, the second classification score, and the third classification score.

In some embodiments, the computing system 101 may generate, based on the data object, a fourth object feature set for a fourth machine learned model associated with a fourth type of machine learning task. In some embodiments, the computing system 101 may apply, by the one or more processors, the fourth machine learned model to the fourth object feature set and the domain knowledge feature set to generate a fourth classification score for the data object. In some embodiments, the computing system 101 may generate, using the machine learned classifier model, the aggregated classification score based on the first classification score, the second classification score, the third classification score, and the fourth classification score.

In some embodiments, the process 900 comprises, at step/operation 912, determining whether the aggregated classification score satisfy a defined threshold. If yes, the process 900 may proceed to step/operation 914. However, if no, the process 900 may proceed to step/operation 916.

In some embodiments, the process 900 comprises, at step/operation 914, initiating the performance of a prediction-based action based on the aggregated classification score. For example, in response to the data processing request, the computing system 101 may transmit one or more data packets that comprise one or more user interface data objects associated with the aggregated classification score.

In some embodiments, the process 900 comprises, at step/operation 916, initiating a rejection status for the data object.

Some techniques of the present disclosure enable the generation of action outputs that may be performed to initiate one or more real world actions to achieve real-world effects. The machine learning and data scaling techniques of the present disclosure may be used, applied, and/or otherwise leveraged to augment a user interface, which may help in the creation and provisioning of messages across computing entities, as well as other downstream tasks such as rendering of a visualization via a user interface. For instance, generative output, using some of the techniques of the present disclosure, may trigger the performance of actions at a client device, such as the display, transmission, and/or the like of data reflective of a visualization. In some embodiments, the visualization may trigger an alert via a user interface.

In some examples, the computing tasks may comprise actions that may be based on a defined domain task and/or a particular computing task. A defined domain task and/or a particular computing task may comprise any environment in which computing systems may be applied to generate a visualization and initiate the performance of computing tasks responsive to a visualization. These actions may cause real-world changes, for example, by controlling a hardware component of a user device or a server device, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

In some embodiments, an action (e.g., a prediction-based action) comprises real-time configuration of a user interface based on the subset of explainable features to enable a user to consume visual data in an interactive manner, where the visual data is tailored based on the aggregated classification score 415. In some embodiments, an action (e.g., a prediction-based action) comprises an automated drug manufacturing, routing, and/or storage action. For instance, responsive to the aggregated classification score 415, the computing architecture 100 may provide one or more instructions to a manufacturing device (e.g., a pharmaceutical manufacturing device, etc.) to cause a development of one or more resources (e.g., one or more pharmaceutical resources, one or more hospital resources, one or more medications, etc.).

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model’s architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model’s architecture and/or their configuration/order, such as the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model comprising one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model’s parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform all of the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising: receiving, by one or more processors, a processing request associated with a data object; generating, by the one or more processors and based on the data object, (i) a first object feature set for a first machine learned model associated with a first type of machine learning task, (ii) a second object feature set for a second machine learned model associated with a second type of machine learning task, and (iii) a domain knowledge feature set associated with a domain knowledge profile for the data object; applying, by the one or more processors, the first machine learned model to the first object feature set and the domain knowledge feature set to generate a first classification score for the data object; applying, by the one or more processors, the second machine learned model to the second object feature set and the domain knowledge feature set to generate a second classification score for the data object; generating, by the one or more processors and using a machine learned classifier model, an aggregated classification score for the data object based on the first classification score and the second classification score; and in response to the data processing request, transmitting, by the one or more processors, one or more data packets that comprise one or more user interface data objects associated with the aggregated classification score.

Example 2. The computer-implemented method of example 1, wherein the first object feature set is an image feature set for the data object, the first classification score generated by the first machine learned model is an image quality classification score for the data object, and generating the aggregated classification score comprises: generating, using the machine learned classifier model, the aggregated classification score for the data object based on the image quality classification score and the second classification score.

Example 3. The computer-implemented method of any of the above examples, wherein the first object feature set is a data content alignment feature set for the data object, the first classification score generated by the first machine learned model is a data content alignment classification score for the data object, and the computer-implemented method further comprises: generating the data content alignment feature set based on a context categorization classification for the data object, and wherein generating the aggregated classification score comprises: generating, using the machine learned classifier model, the aggregated classification score for the data object based on the data content alignment classification score and the second classification score.

Example 4. The computer-implemented method of any of the above examples, further comprising: generating the context categorization classification using a third machine learned model that is trained with a training dataset that comprises a third object feature set for one or more historical data objects.

Example 5. The computer-implemented method of any of the above examples, further comprising: generating the context categorization classification using a third machine learned model that is trained with a training dataset that comprises a third object feature set for one or more historical data processing requests and one or more historical data packets associated with the data processing request.

Example 6. The computer-implemented method of any of the above examples, wherein the first classification score generated by the first machine learned model is a void data classification score for the data object, and generating the aggregated classification score comprises: generating, using the machine learned classifier model, the aggregated classification score for the data object based on the void data classification score and the second classification score.

Example 7. The computer-implemented method of any of the above examples, wherein the first object feature set is a text feature set for the data object, the second object feature set is an image feature set for the data object, the first classification score generated by the first machine learned model is a text quality classification score for the data object, the second classification score generated by the second machine learned model is an image quality classification score for the data object, and generating the aggregated classification score comprises: generating, using the machine learned classifier model, the aggregated classification score for the data object based on the text quality classification score and the image quality classification score.

Example 8. The computer-implemented method of any of the above examples, further comprising: generating, based on the data object, a third object feature set for a third machine learned model associated with a third type of machine learning task; and applying, by the one or more processors, the third machine learned model to the third object feature set and the domain knowledge feature set to generate a third classification score for the data object, wherein generating the aggregated classification score comprises: generating, using the machine learned classifier model, the aggregated classification score based on the first classification score, the second classification score, and the third classification score.

Example 9. The computer-implemented method of any of the above examples, further comprising: generating, based on the data object, a fourth object feature set for a fourth machine learned model associated with a fourth type of machine learning task; and applying, by the one or more processors, the fourth machine learned model to the fourth object feature set and the domain knowledge feature set to generate a fourth classification score for the data object, wherein generating the aggregated classification score comprises: generating, using the machine learned classifier model, the aggregated classification score based on the first classification score, the second classification score, the third classification score, and the fourth classification score.

Example 10. A system comprising: one or more processors; and one or more memories storing processor-executable instructions that, when executed by the one or more processors, cause the one or more processors to perform operations comprising: receiving a processing request associated with a data object; generating, based on the data object, (i) a first object feature set for a first machine learned model associated with a first type of machine learning task, (ii) a second object feature set for a second machine learned model associated with a second type of machine learning task, and (iii) a domain knowledge feature set associated with a domain knowledge profile for the data object; applying the first machine learned model to the first object feature set and the domain knowledge feature set to generate a first classification score for the data object; applying the second machine learned model to the second object feature set and the domain knowledge feature set to generate a second classification score for the data object; generating, using a machine learned classifier model, an aggregated classification score for the data object based on the first classification score and the second classification score; and in response to the data processing request, transmitting one or more data packets that comprise one or more user interface data objects associated with the aggregated classification score.

Example 11. The system of example 10, wherein the first object feature set is an image feature set for the data object, the first classification score generated by the first machine learned model is an image quality classification score for the data object, and generating the aggregated classification score comprises: generating, using the machine learned classifier model, the aggregated classification score for the data object based on the image quality classification score and the second classification score.

Example 12. The system of any of the above examples, wherein the first object feature set is a data content alignment feature set for the data object, the first classification score generated by the first machine learned model is a data content alignment classification score for the data object, and the computer-implemented method further comprises: generating the data content alignment feature set based on a context categorization classification for the data object, and wherein generating the aggregated classification score comprises: generating, using the machine learned classifier model, the aggregated classification score for the data object based on the data content alignment classification score and the second classification score.

Example 13. The system of any of the above examples, wherein the one or more processors further perform operations comprising: generating the context categorization classification using a third machine learned model that is trained with a training dataset that comprises a third object feature set for one or more historical data objects.

Example 14. The system of any of the above examples, wherein the one or more processors further perform operations comprising: generating the context categorization classification using a third machine learned model that is trained with a training dataset that comprises a third object feature set for one or more historical data processing requests and one or more historical data packets associated with the data processing request.

Example 15. The system of any of the above examples, wherein the first classification score generated by the first machine learned model is a void data classification score for the data object, and generating the aggregated classification score comprises: generating, using the machine learned classifier model, the aggregated classification score for the data object based on the void data classification score and the second classification score.

Example 16. The system of any of the above examples, wherein the first object feature set is a text feature set for the data object, the second object feature set is an image feature set for the data object, the first classification score generated by the first machine learned model is a text quality classification score for the data object, the second classification score generated by the second machine learned model is an image quality classification score for the data object, and generating the aggregated classification score comprises: generating, using the machine learned classifier model, the aggregated classification score for the data object based on the text quality classification score and the image quality classification score.

Example 17. The system of any of the above examples, wherein the one or more processors further perform operations comprising: generating, based on the data object, a third object feature set for a third machine learned model associated with a third type of machine learning task; and applying, by the one or more processors, the third machine learned model to the third object feature set and the domain knowledge feature set to generate a third classification score for the data object, wherein generating the aggregated classification score comprises: generating, using the machine learned classifier model, the aggregated classification score based on the first classification score, the second classification score, and the third classification score.

Example 18. The system of any of the above examples, wherein the one or more processors further perform operations comprising: generating, based on the data object, a fourth object feature set for a fourth machine learned model associated with a fourth type of machine learning task; and applying, by the one or more processors, the fourth machine learned model to the fourth object feature set and the domain knowledge feature set to generate a fourth classification score for the data object, wherein generating the aggregated classification score comprises: generating, using the machine learned classifier model, the aggregated classification score based on the first classification score, the second classification score, the third classification score, and the fourth classification score.

Example 19. One or more non-transitory computer-readable media storing processor-executable instructions that, when executed by one or more processors, cause the one or more processors to perform operations comprising: receiving a processing request associated with a data object; generating, based on the data object, (i) a first object feature set for a first machine learned model associated with a first type of machine learning task, (ii) a second object feature set for a second machine learned model associated with a second type of machine learning task, and (iii) a domain knowledge feature set associated with a domain knowledge profile for the data object; applying the first machine learned model to the first object feature set and the domain knowledge feature set to generate a first classification score for the data object; applying the second machine learned model to the second object feature set and the domain knowledge feature set to generate a second classification score for the data object; generating, using a machine learned classifier model, an aggregated classification score for the data object based on the first classification score and the second classification score; and in response to the data processing request, transmitting one or more data packets that comprise one or more user interface data objects associated with the aggregated classification score.

Example 20. The one or more non-transitory computer-readable media of example 19, wherein the first object feature set is a text feature set for the data object, the second object feature set is an image feature set for the data object, the first classification score generated by the first machine learned model is a text quality classification score for the data object, the second classification score generated by the second machine learned model is an image quality classification score for the data object, and generating the aggregated classification score comprises: generating, using the machine learned classifier model, the aggregated classification score for the data object based on the text quality classification score and the image quality classification score.

Example 21. The computer-implemented method of example 1, wherein the method further comprises training the first machine learned model.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The computing system of example 10, wherein the one or more processors are further configured to train the first machine learned model.

Example 25. The computing system of example 24, wherein the one or more processors are comprised in a first computing entity; and the first machine learned model is trained by one or more other processors comprised in a second computing entity.

Example 26. The one or more non-transitory computer-readable storage media of example 19, wherein the instructions further cause the one or more processors to train the first machine learned model.

Example 27. The one or more non-transitory computer-readable storage media of example 26, wherein the one or more processors are comprised in a first computing entity; and the first machine learned model is trained by one or more other processors comprised in a second computing entity.

Example 28. The computer-implemented method of example 1, wherein the method further comprises training the second machine learned model.

Example 29. The computer-implemented method of example 28, wherein the training is performed by the one or more processors.

Example 30. The computer-implemented method of example 28, wherein the one or more processors are comprised in a first computing entity; and the training is performed by one or more other processors comprised in a second computing entity.

Example 31. The computing system of example10, wherein the one or more processors are further configured to train the second machine learned model.

Example 32. The computing system of example 31, wherein the one or more processors are comprised in a first computing entity; and the second machine learned model is trained by one or more other processors comprised in a second computing entity.

Example 33. The one or more non-transitory computer-readable storage media of example 19, wherein the instructions further cause the one or more processors to train the second machine learned model.

Example 34. The one or more non-transitory computer-readable storage media of example 33, wherein the one or more processors are comprised in a first computing entity; and the second machine learned model is trained by one or more other processors comprised in a second computing entity.

1. A computer-implemented method comprising:
receiving, by one or more processors, a processing request associated with a data object;
generating, by the one or more processors and based on the data object, (i) a first object feature set for a first machine learned model associated with a first type of machine learning task, (ii) a second object feature set for a second machine learned model associated with a second type of machine learning task, and (iii) a domain knowledge feature set associated with a domain knowledge profile for the data object;
applying, by the one or more processors, the first machine learned model to the first object feature set and the domain knowledge feature set to generate a first classification score for the data object;
applying, by the one or more processors, the second machine learned model to the second object feature set and the domain knowledge feature set to generate a second classification score for the data object;
generating, by the one or more processors and using a machine learned classifier model, an aggregated classification score for the data object based on the first classification score and the second classification score; and
in response to the data processing request, transmitting, by the one or more processors, one or more data packets that comprise one or more user interface data objects associated with the aggregated classification score.

2. The computer-implemented method of claim 1, wherein the first object feature set is an image feature set for the data object, the first classification score generated by the first machine learned model is an image quality classification score for the data object, and generating the aggregated classification score comprises:
generating, using the machine learned classifier model, the aggregated classification score for the data object based on the image quality classification score and the second classification score.

3. The computer-implemented method of claim 1, wherein the first object feature set is a data content alignment feature set for the data object, the first classification score generated by the first machine learned model is a data content alignment classification score for the data object, and the computer-implemented method further comprises:
generating the data content alignment feature set based on a context categorization classification for the data object, and wherein generating the aggregated classification score comprises:
generating, using the machine learned classifier model, the aggregated classification score for the data object based on the data content alignment classification score and the second classification score.

4. The computer-implemented method of claim 3, further comprising:
generating the context categorization classification using a third machine learned model that is trained with a training dataset that comprises a third object feature set for one or more historical data objects.

5. The computer-implemented method of claim 3, further comprising:
generating the context categorization classification using a third machine learned model that is trained with a training dataset that comprises a third object feature set for one or more historical data processing requests and one or more historical data packets associated with the data processing request.

6. The computer-implemented method of claim 1, wherein the first classification score generated by the first machine learned model is a void data classification score for the data object, and generating the aggregated classification score comprises:
generating, using the machine learned classifier model, the aggregated classification score for the data object based on the void data classification score and the second classification score.

7. The computer-implemented method of claim 1, wherein the first object feature set is a text feature set for the data object, the second object feature set is an image feature set for the data object, the first classification score generated by the first machine learned model is a text quality classification score for the data object, the second classification score generated by the second machine learned model is an image quality classification score for the data object, and generating the aggregated classification score comprises:
generating, using the machine learned classifier model, the aggregated classification score for the data object based on the text quality classification score and the image quality classification score.

8. The computer-implemented method of claim 1, further comprising:
generating, based on the data object, a third object feature set for a third machine learned model associated with a third type of machine learning task; and
applying, by the one or more processors, the third machine learned model to the third object feature set and the domain knowledge feature set to generate a third classification score for the data object,
wherein generating the aggregated classification score comprises:
generating, using the machine learned classifier model, the aggregated classification score based on the first classification score, the second classification score, and the third classification score.

9. The computer-implemented method of claim 8, further comprising:
generating, based on the data object, a fourth object feature set for a fourth machine learned model associated with a fourth type of machine learning task; and
applying, by the one or more processors, the fourth machine learned model to the fourth object feature set and the domain knowledge feature set to generate a fourth classification score for the data object,
wherein generating the aggregated classification score comprises:
generating, using the machine learned classifier model, the aggregated classification score based on the first classification score, the second classification score, the third classification score, and the fourth classification score.

10. A system comprising:
one or more processors; and
one or more memories storing processor-executable instructions that, when executed by the one or more processors, cause the one or more processors to perform operations comprising:
receiving a processing request associated with a data object;
generating, based on the data object, (i) a first object feature set for a first machine learned model associated with a first type of machine learning task, (ii) a second object feature set for a second machine learned model associated with a second type of machine learning task, and (iii) a domain knowledge feature set associated with a domain knowledge profile for the data object;
applying the first machine learned model to the first object feature set and the domain knowledge feature set to generate a first classification score for the data object;
applying the second machine learned model to the second object feature set and the domain knowledge feature set to generate a second classification score for the data object;
generating, using a machine learned classifier model, an aggregated classification score for the data object based on the first classification score and the second classification score; and
in response to the data processing request, transmitting one or more data packets that comprise one or more user interface data objects associated with the aggregated classification score.

11. The system of claim 10, wherein the first object feature set is an image feature set for the data object, the first classification score generated by the first machine learned model is an image quality classification score for the data object, and generating the aggregated classification score comprises:
generating, using the machine learned classifier model, the aggregated classification score for the data object based on the image quality classification score and the second classification score.

12. The system of claim 10, wherein the first object feature set is a data content alignment feature set for the data object, the first classification score generated by the first machine learned model is a data content alignment classification score for the data object, and the computer-implemented method further comprises:
generating the data content alignment feature set based on a context categorization classification for the data object, and wherein generating the aggregated classification score comprises:
generating, using the machine learned classifier model, the aggregated classification score for the data object based on the data content alignment classification score and the second classification score.

13. The system of claim 12, wherein the one or more processors further perform operations comprising:
generating the context categorization classification using a third machine learned model that is trained with a training dataset that comprises a third object feature set for one or more historical data objects.

14. The system of claim 12, wherein the one or more processors further perform operations comprising:
generating the context categorization classification using a third machine learned model that is trained with a training dataset that comprises a third object feature set for one or more historical data processing requests and one or more historical data packets associated with the data processing request.

15. The system of claim 10, wherein the first classification score generated by the first machine learned model is a void data classification score for the data object, and generating the aggregated classification score comprises:
generating, using the machine learned classifier model, the aggregated classification score for the data object based on the void data classification score and the second classification score.

16. The system of claim 10, wherein the first object feature set is a text feature set for the data object, the second object feature set is an image feature set for the data object, the first classification score generated by the first machine learned model is a text quality classification score for the data object, the second classification score generated by the second machine learned model is an image quality classification score for the data object, and generating the aggregated classification score comprises:
generating, using the machine learned classifier model, the aggregated classification score for the data object based on the text quality classification score and the image quality classification score.

17. The system of claim 10, wherein the one or more processors further perform operations comprising:
generating, based on the data object, a third object feature set for a third machine learned model associated with a third type of machine learning task; and
applying, by the one or more processors, the third machine learned model to the third object feature set and the domain knowledge feature set to generate a third classification score for the data object,
wherein generating the aggregated classification score comprises:
generating, using the machine learned classifier model, the aggregated classification score based on the first classification score, the second classification score, and the third classification score.

18. The system of claim 17, wherein the one or more processors further perform operations comprising:
generating, based on the data object, a fourth object feature set for a fourth machine learned model associated with a fourth type of machine learning task; and
applying, by the one or more processors, the fourth machine learned model to the fourth object feature set and the domain knowledge feature set to generate a fourth classification score for the data object,
wherein generating the aggregated classification score comprises:
generating, using the machine learned classifier model, the aggregated classification score based on the first classification score, the second classification score, the third classification score, and the fourth classification score.

19. One or more non-transitory computer-readable media storing processor-executable instructions that, when executed by one or more processors, cause the one or more processors to perform operations comprising:
receiving a processing request associated with a data object;
generating, based on the data object, (i) a first object feature set for a first machine learned model associated with a first type of machine learning task, (ii) a second object feature set for a second machine learned model associated with a second type of machine learning task, and (iii) a domain knowledge feature set associated with a domain knowledge profile for the data object;
applying the first machine learned model to the first object feature set and the domain knowledge feature set to generate a first classification score for the data object;
applying the second machine learned model to the second object feature set and the domain knowledge feature set to generate a second classification score for the data object;
generating, using a machine learned classifier model, an aggregated classification score for the data object based on the first classification score and the second classification score; and
in response to the data processing request, transmitting one or more data packets that comprise one or more user interface data objects associated with the aggregated classification score.

20. The one or more non-transitory computer-readable media of claim 19, wherein the first object feature set is a text feature set for the data object, the second object feature set is an image feature set for the data object, the first classification score generated by the first machine learned model is a text quality classification score for the data object, the second classification score generated by the second machine learned model is an image quality classification score for the data object, and generating the aggregated classification score comprises:
generating, using the machine learned classifier model, the aggregated classification score for the data object based on the text quality classification score and the image quality classification score.
